(19) United States
(12) Patent Application Publication
(10) Pub. No.: US 2021/0379938 A1
(43) Pub. Date: Dec. 9, 2021

(54) SILENT TIRE AND PREPARATION METHOD THEREOF

(71) Applicant: Xiaocun XIANG, Zhangjiagang (CN)

(72) Inventor: Xiaocun XIANG, Zhangjiagang (CN)

(21) Appl. No.: 17/410,595

(22) Filed: Aug. 24, 2021

(30) Foreign Application Priority Data
May 25, 2021 (CN) 202110573820.X

(51) Int. Cl. B60C 19/00; B60C 5/14; B32B 5/18

(52) U.S. Cl. CPC B60C 19/002; B32B 5/18; B60C 5/14

(57) ABSTRACT

A silent tire, including a tire body, which is provided with an inner liner on the inner surface. The tire body includes a tread. A self-seal adhesive layer, a film layer and a sponge layer are sequentially provided on the inner liner corresponding to the position of the tread in a direction away from the tread.

### CROSS-REFERENCE TO RELATED APPLICATIONS

This application claims the benefit of priority from Chinese Patent Application No. 202110573820.X, filed on May 25, 2021. The content of the aforementioned application, including any intervening amendments thereto, is incorporated herein by reference in its entirety.

### TECHNICAL FIELD

The present disclosure relates to tire manufacturing, and more particularly to a silent tire and a preparation method thereof.

### BACKGROUND

Noise will adversely affect the comfort performance of vehicles. Especially, the new energy vehicles that abandon the traditional engine eliminate the interference factors of engine noise. Most of the noise comes from the tire noise caused by the contact between the tire and the ground.

To reduce the noise, there are silent tires on the market. Silent tires are silent sponges adhered to the inside of the tires, and their porous properties have the function of absorbing the resonance between the tire and the road surface. Silent tires can significantly reduce the resonance noise generated by the vehicle during operation, so that it can significantly improve the comfort of driving, especially for the noise reduction of new energy vehicles.

Currently, silent tires generally use polyurethane sponge as the main sound-absorbing material. They glue the polyurethane sponge inside the radial tire to get a silent tire. The polyurethane sponge whose density is 35 to 60 kg/m³ is used as the sound-absorbing material, which has the disadvantages of heavy weight, non-flame retardant, and low temperature resistance with the temperature below 80° C. During the processing, the polyurethane sponge attached to the tire needs to be heated and shaped. The shaping time is about 30 to 40 minutes. The production process is complicated, and there is room for further improvement.

During the processing of the silent sponge tires, the method of sticking polyurethane sponge inside the tire includes double-sided adhesive sticking method. That is, a double-sided adhesive patch with double-sided adhesiveness is used as the sticking medium. One of the two sides of the double-sided adhesive patch is pasted on the inner surface of the tire tread. The other side is pasted on the polyurethane sponge. And the patch combines the polyurethane sponge with the inner surface of the tire tread.

When the vehicle continues to run, the tires constantly vibrate and generate a lot of heat. The tire carcass will also repeatedly expand and contract with heat, and under the constant vibration and alternating effects of cold and heat the double-sided adhesive patch attached to the carcass is prone to fall off. Displacement of the polyurethane sponge from the inner surface of the car tire tread, resulting in abnormal tire dynamic balance and abnormal vibration of the vehicle when driving.

### SUMMARY

The embodiments of the present application provide a silent tire and a preparation method thereof.

To achieve those objectives, the adopted technical solutions are as follows. A silent tire includes a tire body, which is provided with an inner liner on the inner surface. The tire body includes a tread, wherein a self-seal adhesive layer, a film layer, and a sponge layer are sequentially provided on the inner liner corresponding to the position of the tread in a direction away from the tread.

In some embodiments, the tire body is a passenger car radial (PCR) tire.

In some embodiments, the self-seal adhesive layer includes the following weight percentages of raw materials:30% SEBS (styrene-ethylene-butylene-styrene block copolymer), 20% rubber extend oil, 10% polyisobutylene, 20% tackifying resin, 5% carbon black and 15% calcium carbonate.

In some embodiments, the thickness of the self-seal adhesive layer is 2.0-3.5 mm. In some embodiments, the thickness of the self-seal adhesive layer is 3.0 to 3.5 mm.

In some embodiments, the material of the film layer is PVC or PE. The thickness of the film layer is 0.02 to 0.20 mm. In some embodiments, the thickness of the film layer is 0.04 to 0.05 mm.

In some embodiments, the sponge layer is a melamine sponge layer.

In some embodiments, the thickness of the melamine sponge layer is compressed to 40% to 85% of the original thickness of the melamine sponge layer. In some embodiments, the thickness of the melamine sponge layer is compressed to 50% to 66.7% of the original.

In some embodiments, the average pore diameter of the melamine sponge layer is 0.015 to 0.300 mm, and the density of it is 18 to 20 kg/m³.

The embodiment of the present application provides a method for preparing the above-mentioned silent tire, and the method includes the following steps.

S1. Clean the inner liner on the inner surface of the tire body and then dry it.

S2. Heat the self-sealant to the temperature of 180 to 220° C.

S3. Apply the self-sealant prepared in S2 to the surface of the inner liner corresponding to the position of the tread in S1, and form a self-seal adhesive layer on the surface of the inner liner after cooling.

S4. Attach the plastic film to the sponge to obtain a film layer and a sponge layer.

S5. At a temperature of 20 to 40° C., paste the film layer on the sponge layer on the self-seal adhesive layer obtained in the S3, so that the self-seal adhesive layer is bonded with the film layer and the sponge layer into a whole to obtain a silent tire. In some embodiments, the way of coating is to use the coating machine.

In some embodiments, the sponge used in S4 is melamine sponge.

In some embodiments, the thickness of the melamine sponge used in S4 is compressed to 40% to 85% of the original thickness before the film is attached to the sponge.

Compared to the prior art, this application has the following beneficial effects.

In the silent tire provided herein, by adding a film layer between the self-seal adhesive layer and the sponge layer, the bonding firmness of the self-seal adhesive layer and the sponge layer is enhanced. Therefore, the sponge will not shift or fall off during the continuous movement of the tire, preventing the sponge from falling off under conditions of high speed, high temperature and centrifugal force.

### BRIEF DESCRIPTION OF THE DRAWINGS

This FIGURE is a structural diagram of a silent tire according to an embodiment of the present disclosure.

In the drawing, 1, tire inner liner; 2, tire tread; 3, self-seal adhesive layer; 4, film layer; and 5, sponge layer.

### DETAILED DESCRIPTION OF EMBODIMENTS

The disclosure will be described in detail below with reference to the embodiments to make the objects, technical solutions and advantages of the disclosure clearer.

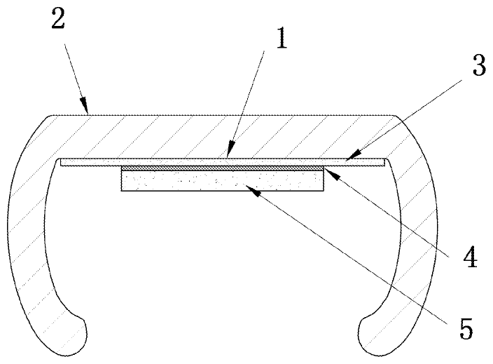

An embodiment shown in FIG. 1 provides a silent tire, which includes a tire body. The inner surface of the tire body is provided with an inner liner 1. The tire body includes a tread 2, where the inner liner corresponding to the position of the tread 2 is sequentially provided with a self-seal adhesive layer 3, a film layer 4 and a sponge layer 5 in the direction away from the tread 2.

The tire body can be a car radial tire. The self-seal adhesive layer 3 can be made of various self-sealants or raw materials including: 30% by weight of SEBS (Styrene-ethylene-butylene-styrene block copolymer), 20% by weight of rubber extend oil, 10% by weight of polyisobutylene, 20% by weight of tackifying resin, 5% by weight of carbon black and 15% by weight of calcium carbonate. The self-sealant can be heated by high temperature of 180 to 220° C., and sprayed onto the inner liner layer by thermal spraying. The spraying width of the self-sealant is equal to or smaller than the width of the inner liner corresponding to the position of the tread 2. Follow the direction of constant speed on the circumference of the car radial tire for a whole week. The use of thermal spraying can reduce the consumption of the self-sealant, and the sealant can be applied at 20-40° C. to bind the self-seal adhesive layer 3, the film layer 4 and the sponge layer 5 together. And the paste is very firm to ensure that it will not fall off during driving so that it is suitable for industrial promotion.

The suitable thickness range of the self-seal adhesive layer 3 is 2.0 to 3.5 mm. The purpose of adding the plastic film layer 4 between the self-seal adhesive layer 3 and sponge layer 5 is to make the two layers stick more firmly. Without the film layer 4, it can not achieve the firm bonding between the self-seal adhesive layer 3 and the sponge layer 5. The material of the plastic film layer 4 can be PVC or PE. And the suitable thickness of the plastic film layer is 0.02 to 0.20 mm.

The sponge layer 5 is preferably a melamine sponge. The suitable average pore diameter of the melamine sponge layer is 0.015 to 0.300 mm. The melamine sponge whose density is 10 to 20 kg/m³ is ultra-lightweight, with fine pore size, good sound absorption, permanent flame retardancy, resistance to high temperature of 200° C. and resistance to dynamic fatigue. Moreover, the cost of melamine sponge material is lower than the others, and it is easy to stick firmly. The silent tire obtained by using the melamine sponge will not shift or fall off during continuous movement, and the melamine sponge has a better sound absorption effect. The use of melamine sponge can reduce the amount of the used sponge. And it is convenient for processing and suitable for automated assembly line production.

Thermal compression of the melamine sponge can improve the toughness of the melamine sponge, so that the melamine sponge will not be brittle due to folding during processing. It is suitable that the thickness of the melamine sponge layer is compressed to 40% to 85% of its original thickness.

### Embodiment 1

This embodiment provides a method of preparing the silent tire and the steps are as follows.

S1. Clean the inner surface of the car radial tire and then dry it.

S2. Heat the self-sealant adhesive to 220° C., where the self-sealant includes the following raw materials in weight percentage: 30% SEBS (styrene-ethylene-butylene-styrene block copolymer), 20% rubber extend oil, 10% polyisobutylene, 20% tackifying resin, 5% carbon black and 15% calcium carbonate.

S3. Apply the self-sealant prepared in S2 to the surface of the inner liner corresponding to the position of the tread in S1 through a coating machine. After cooling, a self-seal adhesive layer is formed on the surface of the inner liner layer, and the thickness of the self-seal adhesive layer is 3.5 mm.

S4. The thickness of the melamine sponge is compressed by a thermal compression. The thickness of the original melamine sponge layer is 30 mm. Then compress the sponge layer to 20 mm by heat, and the thickness of the melamine sponge layer is 66.7% of the original thickness. The pore size of the compressed melamine sponge is 0.07 mm, and the density is 18 kg/m³. Attach the PVC plastic film layer to the compressed melamine sponge. The thickness of the PVC plastic film is 0.04 mm. Connect the melamine sponge and the PVC plastic film as a whole, then the PVC plastic film layer and the melamine sponge layer are obtained;

S5. At 25° C., stick the PVC plastic film layer on the melamine sponge layer on the self-seal adhesive layer obtained in the S3, so that the self-seal adhesive layer is bonded with the PVC plastic film layer and the melamine sponge layer as a whole to obtain a silent tire.

### Embodiment 2

This embodiment provides a method of preparing a silent tire and the steps are as follows.

S1. Clean the inner surface of the car radial tire and then dry it.

S2. Heat the self-sealant adhesive to 220° C. And the self-sealant includes the following raw materials in weight percentage: 30% SEBS (styrene-ethylene-butylene-styrene block copolymer), 20% rubber extend oil, 10% polyisobutylene, 20% tackifying resin, 5% carbon black and 15% calcium carbonate.

S3. Apply the self-sealant prepared in S2 to the surface of the inner liner corresponding to the position of the tread in S1 through a coating machine. After cooling, a self-seal adhesive layer is formed on the surface of the inner liner layer, and the thickness of the self-seal adhesive layer is 3.0 mm.

S4. The thickness of the melamine sponge is compressed by a thermal compression. The thickness of the original melamine sponge layer is 40 mm. Then compress the sponge layer to 20 mm by heat, and the thickness of the melamine sponge layer is 50% of the original thickness. The pore size of the compressed melamine sponge is 0.05 mm, and the density is 20 kg/m³. Attach the PE plastic film layer to the compressed melamine sponge. The thickness of the PE plastic film is 0.05 mm. Connect the melamine sponge and the PE plastic film as a whole, then the PE plastic film layer and the melamine sponge layer are obtained;

S5. At 25° C., stick the PE plastic film layer on the melamine sponge layer on the self-seal adhesive layer obtained in the S3, so that the self-seal adhesive layer is bonded with the PE plastic film layer and the melamine sponge layer as a whole to obtain a silent tire.

### Comparative Embodiment 1

This comparison provides a method of preparing the silent tire and the steps are as follows.

S1. The inner surface of the car radial tire is cleaned and dried.

S2. Heat the self-sealant adhesive to 220° C. And the self-sealant includes the following raw materials in weight percentage: 30% SEBS (styrene-ethylene-butylene-styrene block copolymer), 20% rubber extend oil, 10% polyisobutylene, 20% tackifying resin, 5% carbon black and 15% calcium carbonate.

S3. Apply the self-sealant prepared in S2 to the surface of the inner liner corresponding to the position of the tread in S1 through a coating machine. After cooling, a self-seal adhesive layer is formed on the surface of the inner liner layer, and the thickness of the self-seal adhesive layer is 3.5 mm.

S4. The thickness of the melamine sponge is compressed by a thermal compression. The thickness of the original melamine sponge layer is 30 mm. Then compress the sponge layer to 20 mm by heat, and the thickness of the melamine sponge layer is 66.7% of the original thickness. The pore size of the compressed melamine sponge is 0.07 mm, and the density is 18 kg/m³.

S5. At 25° C., stick the melamine sponge layer on the self-seal adhesive layer obtained in the S3, so that the self-seal adhesive layer is bonded with the melamine sponge layer as a whole to obtain a silent tire.

The bonding firmness between the self-seal adhesive layer and the sponge layer in the silent tires prepared in Embodiments 1 and 2 and Comparative Embodiment 1 were tested, and the results are shown in Table 1.

TABLE 1
Test results of binding firmness
Test of the bonding degree between the melamine sponge layer and
the self-seal adhesive layer after driving 60,000 kilometers on the road

| | Specifications | |
|---|---|---|
| Group | 225/55R17 | 255/55R18 |
| Embodiment 1 (PVC) | 0% | 0% |
| Embodiment 2 (PE) | 0% | 0% |
| Comparison 1 (Without the film layer) | Fall off | Fall off |

It can be seen from the Table 1 that in the binding firmness test of the silent tire without film layer of Comparative embodiment 1, the melamine sponge layer falls off from the self-seal adhesive layer. However, in embodiment 1 and 2, the results are shown that the bonding between the melamine sponge layer and the self-seal adhesive layer is very firm. It shows that adding the film layer can enhance the bonding firmness between the self-seal adhesive layer and the sponge layer.

Described above are preferred embodiments of the disclosure, which are merely illustrative of the disclosure and are not intended to limit the disclosure. It should be understood that any modifications, replacements and changes made by those skilled in the art without departing from the spirit of the disclosure should fall within the scope of the disclosure defined by the appended claims.

What is claimed is:

1. A silent tire, comprising:
a tire body;
wherein an inner surface of the tire body is provided with an inner liner; the tire body comprises a tread; and a self-seal adhesive layer, a film layer and a sponge layer are sequentially provided on the inner liner corresponding to a position of the tread in a direction away from the tread.

2. The silent tire of claim 1, wherein the tire body is a passenger car radial (PCR) tire.

3. The silent tire of claim 1, wherein a thickness of the self-seal adhesive layer is 2.0-3.5 mm.

4. The silent tire of claim 1, wherein the film layer is made of a plastic material, and a thickness of the film layer is 0.02-0.20 mm.

5. The silent tire of claim 1, wherein the sponge layer is a melamine sponge layer.

6. The silent tire of claim 5, wherein a thickness of the melamine sponge layer is compressed to 40%-85% of an original thickness of the melamine sponge layer.

7. The silent tire of claim 5, wherein an average pore size of the melamine sponge layer is 0.015-0.300 mm; and a density of the melamine sponge layer is 10-30 kg/m³.

8. A method for preparing the silent tire of claim 1, comprising:
(1) cleaning the inner liner on the inner surface of the tire body followed by drying;
(2) heating a self-seal adhesive to 220° C.;
(3) applying the heated self-seal adhesive obtained in (2) to a surface of the inner liner corresponding to the position of the tread followed by cooling to form the self-seal adhesive layer on the surface of the inner liner;
(4) attaching a plastic film to a sponge to obtain the film layer and the sponge layer; and
(5) sticking the film layer on the sponge layer to the self-seal adhesive layer obtained in step (3) at 20° C.-40° C., so that the self-seal adhesive layer is bonded with the film layer and the sponge layer into a whole to obtain the silent tire.

9. The method of claim 8, wherein in step (4), the sponge is a melamine sponge.

10. The method of claim 9, wherein in step (4), a thickness of the melamine sponge is compressed to 40%-85% of an original thickness of the melamine sponge before attaching the plastic film to the melamine sponge.
